(19) United States
(12) Patent Application Publication
(10) Pub. No.: US 2025/0381606 A1
(43) Pub. Date: Dec. 18, 2025

(54) MACHINING SYSTEMS AND METHODS

(71) Applicant: Voortman Steel Machinery Holding B.V., Rijssen (NL)

(72) Inventor: Frans Herman VOLMER, Rijssen (NL)

(21) Appl. No.: 19/107,870

(22) PCT Filed: Nov. 9, 2023
(86) PCT No.: PCT/NL2023/050588

§ 371 Date: Feb. 28, 2025

(30) Foreign Application Priority Data
Nov. 10, 2022 (NL) 2033500

(51) Int. Cl. B23D 53/04; B23D 53/08; B23D 55/04

(52) U.S. Cl. CPC B23D 53/04; B23D 53/08; B23D 55/04

(57) ABSTRACT

A machining system (2) for sawing a metal workpiece (4). The machining system (2) comprises a conveying assembly (6) configured to convey the workpiece (4) thereon downstream along a transport path (8) in the X-direction and a sawing assembly (10) arranged along the transport path (8). The machining system (2) additionally comprises a downstream clamping assembly (34) having a first and a second downstream clamping element (26, 30). The downstream clamping assembly (34) is decoupled from the rotatability of the band saw frame (14). Both the first and the second downstream clamping element (26, 30) are moveably arranged in an upstream and a downstream direction along the X-direction for transporting a sawn-off workpiece section (4b) away from the sawing assembly (10) in the downstream direction along the X-direction and the first downstream clamping element (26) is moveably arranged relative to the second downstream clamping element (30) in the upstream and the downstream direction along the X-direction.

### FIELD

The present disclosure relates to a machining system for sawing a metal workpiece, as well as to a method of sawing a metal workpiece. The disclosure also relates to: a method of transporting an elongate metal workpiece; a gripper assembly; a gripper truck assembly; machining systems for machining an elongate metal workpiece; and methods of machining an elongate metal workpiece.

### BACKGROUND

Machining systems are known as such, for example for machining so-called structural steel elongate workpieces. Known machining systems are configured to perform various machining operations on the workpieces, including drilling and sawing, in particularly largely automatically. Typically, the workpiece to be machined is transported, for example by a gripper truck assembly, with respect to one or more machining stations, in a transport direction parallel to the workpiece's longitudinal axis, to position the workpiece with respect to the machining station in accordance with a predetermined machining position along the workpiece. Various types of machining stations may be arranged along the transport direction, for example one after another, so as to enable a variety of machining operations to be performed using the machining system.

There is an ongoing need for improvements in the field of machining systems for metal workpieces.

### SUMMARY

An object is to improve efficiency, versatility, reliability, and/or another quality in the machining of metal workpieces, in particular so-called structural steel workpieces.

A first aspect provides a machining system for sawing a metal workpiece. The machining system defines an orthogonal X-, Y-, Z-coordinate system of which an X-direction is horizontal, a Y-direction is horizontal and perpendicular to the X-direction and a Z-direction is vertical. The workpiece has a workpiece main axis which is parallel to the X-direction, a first lateral outer side and a second lateral outer side which is opposite the first lateral outer side both lateral sides extending parallel to the X-direction.

According to the first aspect, the machining system comprises a conveying assembly configured to convey the workpiece thereon downstream along a transport path in the X-direction with the second lateral outer side extending in a vertical datum line plane which is defined by the machining system and extends in the X-direction. The workpiece is at a frontside of the vertical datum line plane.

According to the first aspect, the machining system comprises a sawing assembly arranged along the transport path and configured to saw the workpiece along a horizontal sawing path which extends across the transport path at a predetermined sawing angle with respect to the Y-direction. The sawing path divides the workpiece in an upstream workpiece section and a downstream workpiece section. The sawing assembly comprising a band saw frame which is rotatable with respect to the conveying assembly about a vertical band saw frame rotation axis so as to vary the predetermined sawing angle within a range of possible sawing angles. The possible sawing angles include:

a negative sawing angle range in which the band saw frame extends from the saw frame rotation axis across the transport path in an area downstream from the band saw frame rotation axis;

a positive sawing angle range in which the band saw frame extends from the saw frame rotation axis across the transport path in an area upstream from the band saw frame rotation axis;

a zero sawing angle in which the band saw frame extends from the saw frame rotation axis across the transport path in the Y-direction.

According to the first aspect, the machining system comprises a downstream clamping assembly having a first downstream clamping element for laterally engaging the first lateral outer side of the workpiece and having a second downstream clamping element for laterally engaging the second lateral outer side of the workpiece. The downstream clamping assembly is decoupled from the rotatability of the band saw frame. The first downstream clamping element is moveable towards and away from the second downstream clamping element. Both the first and the second downstream clamping element are moveably arranged in an upstream and a downstream direction along the X-direction for transporting a sawn-off workpiece section away from the sawing assembly in the downstream direction along the X-direction. Additionally, the first downstream clamping element is moveably arranged relative to the second downstream clamping element in the upstream and the downstream direction along the X-direction.

The downstream clamping assembly is able to clamp a downstream workpiece section, i.e. a workpiece section of the workpiece that is downstream of the sawing path when the first and the second lateral outer sides of the downstream workpiece section are long enough. In this respect, “long enough” means extending at least along 15 mm in the X-direction. Due to the fact that the first downstream clamping element is moveably arranged relative to the second downstream clamping element in the upstream and the downstream direction along the X-direction, the first downstream clamping element can be positioned close, i.e. preferably within 20 mm, more preferably within 10 mm of the sawing path at least when the sawing path extends in the negative sawing angle range or when the sawing angle equals zero. The second downstream clamping element will normally, i.e. during the sawing action, also be positioned close to the sawing path, in particular close to the vertical band saw frame rotation axis. By virtue of the possibility to position both the first downstream clamping element and the second downstream clamping element close to the sawing path when the sawing path extends in the negative sawing angle range or along the zero sawing angle, a very stable clamping of the downstream workpiece section is realized, independently of the sawing angle of the sawing path within these ranges. When the sawing angle of the sawing path is zero or is in the positive angle range, the first downstream clamping element is preferably positioned along the X-direction so as to be perpendicularly opposite the second downstream clamping element. In this way, it is prevented that at the saw cut the downstream workpiece section and the upstream workpiece section are pressed towards each other and the saw cut is closed thereby inhibiting or blocking the movement of the saw blade. Additionally, by virtue of the fact that both the first and the second downstream clamping element are moveably arranged in an upstream and a downstream direction along the X-direction, it is feasible to transport a sawn-off downstream workpiece section away from the sawing assembly in the downstream direction along the X-direction. Very short downstream workpiece sections can be produced because these downstream workpiece sections are held by the downstream clamping assembly and by virtue thereof will not fall down in an optional passage in the conveying assembly at the sawing assembly. By laterally engaging the downstream workpiece section close to the sawing path, a particularly good stabilization can be provided and so the workpiece can be sawn particularly reliably, precisely and neatly generally, and in particular even also for relatively sharp negative sawing angles and/or relatively short workpiece sections.

By the clamping assembly being decoupled from the rotatability of the band saw frame, the workpiece can be clamped without thereby urging the band saw frame to rotate as a result of reaction forces. In known sawing systems, such urging does occur during use, so that sufficient countermeasures have to be in place, for example in the form of a heavy braking mechanism for the rotatable band saw frame with which unwanted rotation of the rotatable band saw frame is prevented. The invention according to the first aspect advantageously obviates the need for such countermeasures while still providing the above described advantages of stabilization close to the sawing path for various sawing angles.

In a further elaboration, the machining system may comprise an upstream clamping assembly having a first upstream clamping element for laterally engaging the first lateral outer side of the workpiece and having a second upstream clamping element for laterally engaging the second lateral outer side of the workpiece. In this further elaboration, the upstream clamping assembly is decoupled from the rotatability of the band saw frame. The first upstream clamping element is movably arranged along a first horizontal clamping path extending with clamping angle relative to X-direction. The first upstream clamping element is additionally moveably arranged upstream and downstream along a path parallel to the X-direction.

The upstream clamping assembly is able to clamp an upstream workpiece section, i.e. a workpiece section that is upstream from the sawing path. This may be applicable when at least one of the first and the second lateral outer sides of the downstream workpiece section is too short to firmly clamp the downstream workpiece section with the first and second downstream clamping elements. By virtue of the fact that the upstream clamping assembly is decoupled from the rotatability of the band saw frame, again, the workpiece can be clamped without thereby urging the band saw frame to rotate as a result of reaction forces as explained above. Additionally, due to the fact that the first upstream clamping element is moveably arranged along a first horizontal clamping path extending with a clamping angle relative to the X-direction, the first upstream clamping element does not interfere with the band saw even if the band saw extends at a positive band sawing angle. Further, because the first upstream clamping element is additionally moveably arranged upstream and downstream along a path parallel to the X-direction, the first upstream clamping element can be positioned close to the sawing path, i.e. within 20 mm and more preferably within 10 mm from the sawing path when the sawing angle of the sawing path is within the positive sawing angle range. The movability along the X-direction of the first upstream clamping element allows to position of the first upstream clamping element perpendicularly opposite the second upstream clamping element when the sawing angle of the sawing path is zero or is within the negative sawing angle range. Although not being moveable along the X-direction, the clamping end of the second upstream clamping element is positioned close to the vertical band saw frame rotation axis and thus also close to the sawing path, in particular within 20 mm and more preferably within 10 mm of the sawing path. Thus, the upstream workpiece section can be clamped by the upstream clamping assembly in a very stable manner close to the sawing path. Thus, the workpiece can be sawn particularly reliably, precisely and neatly generally, and in particular also even when the positive sawing angle of the sawing path is relatively sharp.

A second aspect provides a method of sawing a metal workpiece to divide the workpiece in an upstream workpiece section and a downstream workpiece section. The workpiece has a workpiece main axis, a first lateral outer side and a second lateral outer side which is opposite the first lateral outer side. The method comprises:
providing a machining system according to the first aspect;
conveying the workpiece on the conveying assembly along the transport path in the X-direction to the sawing assembly with the workpiece main axis parallel to the X-direction and the second lateral outer side extending in the vertical datum line plane and the workpiece being at a frontside of the vertical datum line plane;
using the downstream clamping assembly when the first and second lateral outer sides of the downstream workpiece section are long enough to firmly clamp the downstream workpiece section with the first and second downstream clamping elements, wherein the using of the downstream clamping assembly includes:
   positioning at least the first downstream clamping element along the X-direction so as to be within a predetermined distance from a sawing path when the sawing angle of the sawing path is within the negative sawing angle range, wherein predetermined distance is less than 20 mm, preferably less than 10 mm, or alternatively
   positioning at least the first downstream clamping element perpendicularly opposite the second downstream clamping element when the sawing angle of the sawing path is zero or is within the positive sawing angle range; and
   moving the first downstream clamping element towards the second downstream clamping element to clamp the downstream workpiece section of the workpiece;
using the sawing assembly during the clamping of the downstream workpiece section to saw off the downstream workpiece section; and
transporting the downstream workpiece section which has been sawn-off away from the sawing assembly downstream along the X-direction by simultaneously moving the first and the second downstream clamping elements downstream along the X-direction.

Such a method provides advantages as explained above with respect to the first aspect. Again, the wording “long enough to firmly clamp the downstream workpiece section” requires that first and the second lateral outer sides of the downstream workpiece section extend at least along 15 mm in the X-direction.

In a further elaboration of the second aspect, when the machining system is in accordance with the further elaboration as described above, the method may comprise:
using the upstream clamping assembly when at least one of the first and the second lateral outer sides of the downstream workpiece section (4b) is too short to firmly clamp the downstream workpiece section with the first and second downstream clamping elements, wherein the using of the upstream clamping assembly includes:
positioning at least the first upstream clamping element along the X-direction so as to be within a predetermined distance from a sawing path during the actual clamping when the sawing angle of the sawing path is within the positive sawing angle range, wherein predetermined distance is less than 20 mm, preferably less than 10 mm, or alternatively
positioning the first upstream clamping element along the path parallel to the X-direction so as to be perpendicularly opposite the second upstream clamping element during the actual clamping when the sawing angle of the sawing path is zero or is within the negative sawing angle range, and
moving the first upstream clamping element towards the second upstream clamping element to clamp the upstream workpiece section of the workpiece;
using the sawing assembly during the clamping of the upstream workpiece section to saw off the downstream workpiece section.

This further elaboration of the method according to the second aspect provides advantages as explained above with respect to further elaboration of the machining system according to the first aspect.

A third aspect provides a method of transporting an elongate metal workpiece with respect to a machining station defining an orthogonal X,Y,Z-coordinate system of which an X-direction is horizontal, a Y-direction is horizontally extending perpendicular to the X-direction and a Z-direction is vertical. The elongate workpiece has a workpiece main axis substantially parallel to the X-direction and extending between a first and a second workpiece axial end. The workpiece also has two lateral opposite outer sides each extending in a respective vertical plane extending parallel to the X- and Z-directions.

According to the third aspect, the method comprises: gripping the elongate workpiece at the first workpiece axial end by a gripper assembly extending along the X-direction from a gripper truck, wherein the gripping comprises, by the gripper assembly, engaging the opposite lateral outer sides of the workpiece at the first workpiece axial end; and, while the workpiece continues to be gripped by the gripper assembly, driving the gripper truck to thereby transport the workpiece in the transport direction with respect to the machining station.

By engaging the opposite lateral outer sides, a large variety of workpieces can be gripped and transported, in particular automatically without operator involvement. In conventional methods, workpieces are gripped by a gripper assembly engaging e.g. a central body portion or a flange of the workpiece, which has been found to lead to complications such as requiring special adaptations to the machining system and/or to the workpiece, and some workpieces getting stuck during the transporting.

A fourth aspect provides a gripper assembly for gripping an elongate metal workpiece for transporting the elongate workpiece in a transport direction with respect to a machining station. The machining station defines an orthogonal X,Y,Z-coordinate system of which an X-direction is horizontal, a Y-direction is horizontally extending perpendicular to the X-direction and a Z-direction is vertical The elongate workpiece has a workpiece main axis substantially parallel to the X-direction and extending between a first and a second workpiece axial end. The workpiece has two lateral opposite outer sides each extending in a respective vertical plane extending parallel to the X- and Z-directions.

According to the fourth aspect, the gripper assembly comprises an elongate gripper arm having a gripper arm main axis and extending between a gripper arm proximal end and a gripper arm distal end, the gripper arm being configured to connect to a gripper truck at the gripper arm proximal end with the gripper arm main axis substantially parallel to the X-direction.

According to the fourth aspect, the gripper assembly comprises a gripper head connected to the gripper arm at the gripper arm distal end and configured to grip the workpiece at the first workpiece axial end which faces the gripper assembly, wherein, for the gripping of the workpiece, the gripper head is configured to engage the opposite lateral outer sides of the workpiece at the first workpiece axial end.

Such a gripper assembly can be used in a method of transporting according to the third aspect, in particular as part of a gripper truck assembly as explained below, and thereby provides corresponding advantages.

A fifth aspect provides a gripper truck assembly for transporting an elongate workpiece in an X-direction with respect to a machining station, the elongate workpiece having a workpiece main axis substantially parallel to the X-direction and extending between workpiece axial ends.

According to the fifth aspect, the gripper truck assembly comprises: a gripper assembly according to the fourth aspect; and a gripper truck which is drivable along the X-direction.

According to the fifth aspect, the gripper arm of the gripper assembly is connected to the gripper truck at the gripper arm proximal end with the gripper arm main axis substantially parallel to the X-direction.

Such a gripper truck assembly can be used in a method of transporting according to the third aspect and thereby provides corresponding advantages.

A sixth aspect provides a machining system for machining an elongate metal workpiece. The machining system defines an orthogonal X, Y,Z-coordinate system of which an X-direction is horizontal, a Y-direction is horizontal direction extending perpendicular to the X-direction and a Z-direction is vertical. The elongate metal workpiece has a workpiece main axis and extending between workpiece axial ends, the workpiece main axis extending in the X-direction. The workpiece has two lateral opposite outer sides each extending in a respective vertical plane extending parallel to the X- and Z-directions.

According to the sixth aspect, the machining system comprises: a gripper truck assembly according to the fifth aspect; and a machining station configured to machine the workpiece while the workpiece is gripped by the gripper assembly of the gripper truck assembly, at a machining position along the workpiece main axis which is dependent on a transporting of the workpiece with respect to the machining station by the gripper truck assembly.

Such a machining system enables reliable automatic machining of a large variety of workpieces, in particular in view of the advantages explained above for the third aspect.

A seventh aspect provides a method of machining an elongate metal workpiece having a workpiece main axis and extending between workpiece axial ends, the method comprising: providing a machining system according to the sixth aspect; using the gripper truck assembly of the machining system for transporting the workpiece with respect to the machining station of the machining system; and during and/or after at least some of the transporting, machining the workpiece at the machining station of the machining system.

Such a machining method provides advantages as explained above for the third to sixth aspects. A machining operation which may be performed after the transporting may e.g. be sawing and drilling. A machining operation which may be performed during the transporting may e.g. be marking and milling.

An eighth aspect provides a machining system defining an orthogonal X, Y,Z-coordinate system of which an X-direction is horizontal, a Y-direction is horizontally extending perpendicular to the X-direction and a Z-direction is vertical, the machining system. The machining system is configured for machining an elongate metal workpiece having a workpiece main axis extending in the X-direction. The workpiece has a first lateral outer side and an opposite second lateral outer side each extending in a respective vertical plane extending parallel to the X- and Z-directions.

According to the eighth aspect, the machining system comprises:

a conveying assembly extending in the X-direction and configured for conveying the workpiece thereon along the X-direction;

at least one machining station arranged along the conveying assembly and configured to machine the workpiece while the workpiece is on the conveying assembly, wherein the machining station comprises at least one clamping element for clamping the workpiece at the first lateral outer side; and one or more lateral limiting elements configured to limit a position of the workpiece on the conveying assembly to a predetermined lateral limit by engagement of the second lateral outer side of the workpiece.

According to the eighth aspect, the one or more lateral limiting elements are adjustable between a limiting state and a permitting state, wherein in the limiting state the lateral limiting element is configured to limit the position of the workpiece on the conveying assembly to the predetermined lateral limit at the respective lateral limiting element, wherein in the permitting state the lateral limiting element is configured to permit one or more objects on the conveying assembly to extend beyond the predetermined lateral limit at the respective lateral limiting element.

The one or more objects on the conveying assembly may in particular include one or more parts of a gripper assembly, for example according to the third aspect. Thus, in the permitting state the lateral limiting elements can advantageously provide room for such a gripper assembly or other object to move past the limiting element in the X-direction while extending beyond the predetermined lateral limit. This may be desired for example when the gripper assembly grips the workpiece by engaging opposite lateral outer sides of the workpiece. In the limiting state, the limiting element can advantageously enforce the predetermined lateral limit for the workpiece on the conveying assembly, e.g. similar to such enforcement by fixed lateral limiting elements in a known machining system.

A ninth aspect provides a method of machining an elongate metal workpiece having a workpiece main axis, comprising: providing a machining system according to the eighth aspect; conveying the workpiece on the conveying assembly along the X-direction with respect to the machining station with the workpiece main axis substantially parallel to the X-direction, wherein, during the conveying, at least one of the one or more lateral limiting elements is adjusted between the limiting state and the permitting state; and after at least some of the conveying, machining the workpiece at the machining station while the workpiece is on the conveying assembly.

Such a method provides advantages as explained above for the eighth aspect.

In view of the present disclosure as a whole, with particular reference to the detailed description and the numbered embodiments presented herein, it shall be appreciated that various combinations of the above aspects may be provided in a same embodiment, for example in a combined machining system and/or a combined machining method. Moreover, it shall be appreciated that features described for a system and/or assembly may be correspondingly applied to a method, and vice versa. For example, a system and/or assembly may be configured to perform and/or may be used in part or all of a method. Further, various advantageous elaborations of the above aspects may be provided, as explained in the detailed description below. It shall be appreciated that such optional elaborations may also be variously combined, including across the various aspects.

### DETAILED DESCRIPTION

In the following, the invention will be explained further using examples of embodiments and drawings. Merely for clarity and conciseness, embodiments and features may be described herein as particularly relating to a particular aspect, wherein it shall be appreciated that such features may be correspondingly applied for one or more other aspects, for example in a combined or overall machining system and/or machining method. The drawings are schematic and merely show examples. In the drawings, corresponding elements have been indicated using corresponding reference signs. In the drawings:

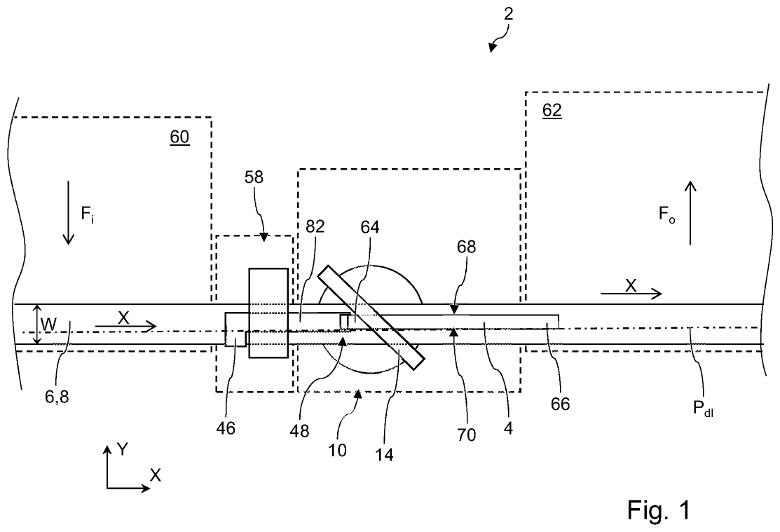

FIG. 1 shows a plan view of a machining system;

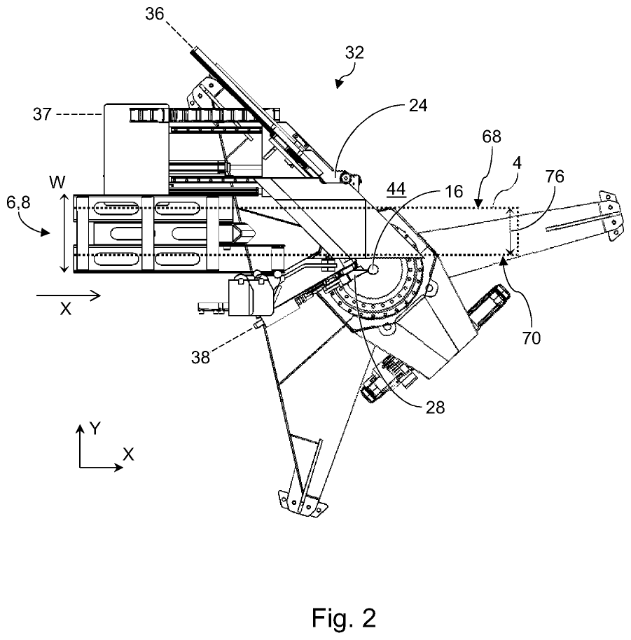

FIG. 2 shows a top view of part of a machining system, in particular a part associated with a sawing assembly;

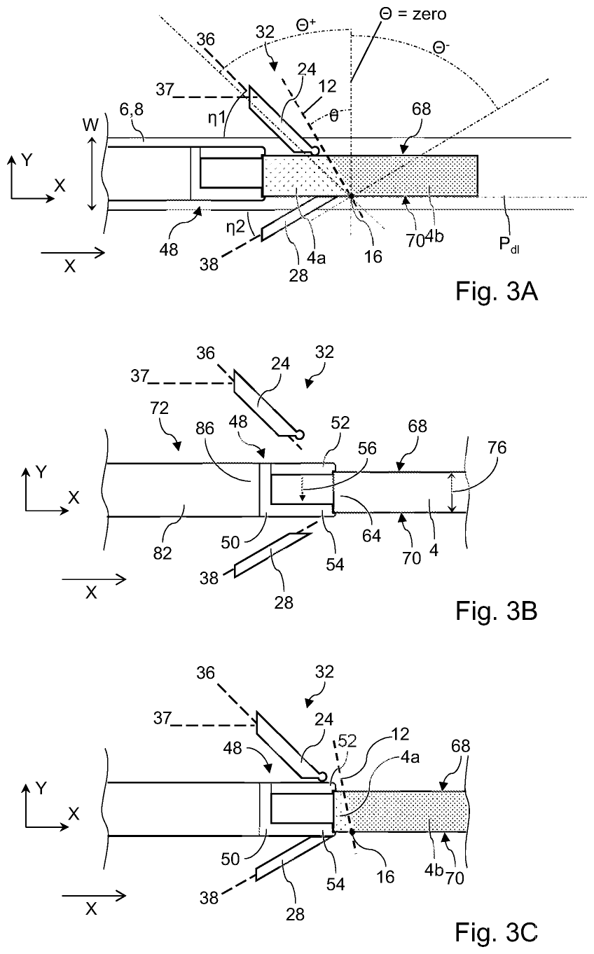

FIGS. 3A-C show top views of the upstream clamping assembly in various states, in particular at a sawing assembly;

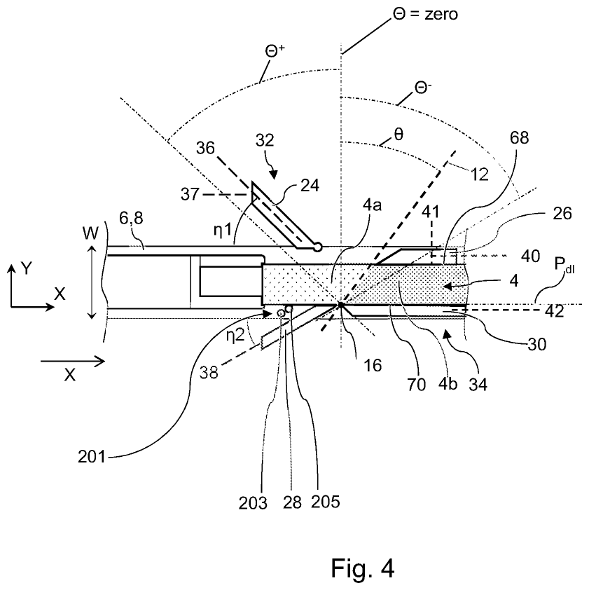

FIG. 4 shows a top view of the downstream clamping assembly in the active state, in particular at the sawing assembly;

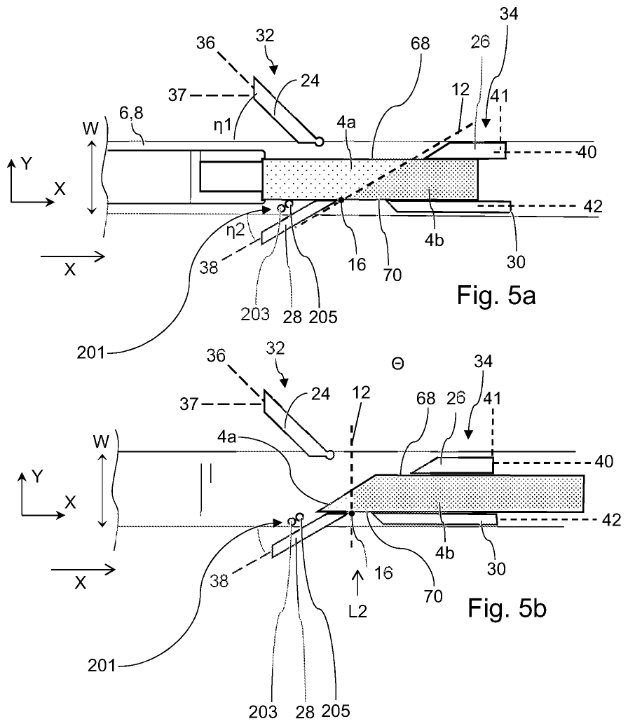

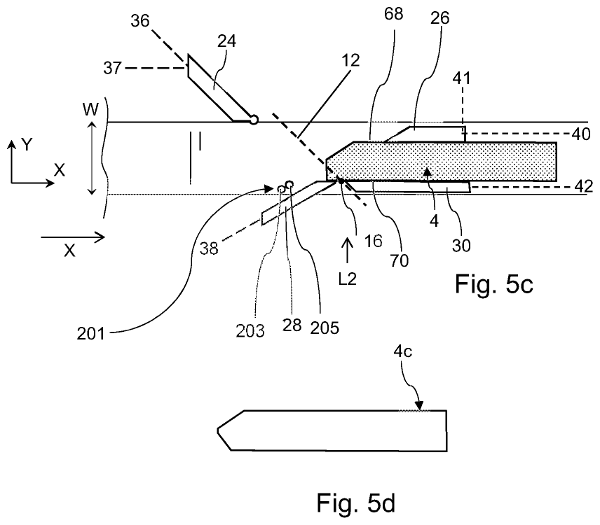

FIG. 5A-5C show top views of the downstream clamping assembly in various states to provide a particular form to the upstream end of a downstream workpiece section;

FIG. 5D shows an example of a configuration in which the upstream end of a downstream workpiece section is formed by three saw cuts;

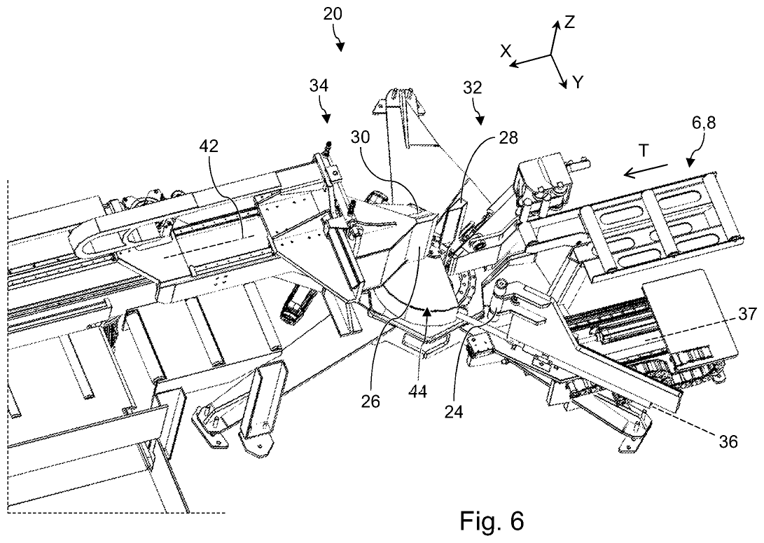

FIG. 6 shows a perspective view of part of a machining system, in particular a part associated with a sawing assembly;

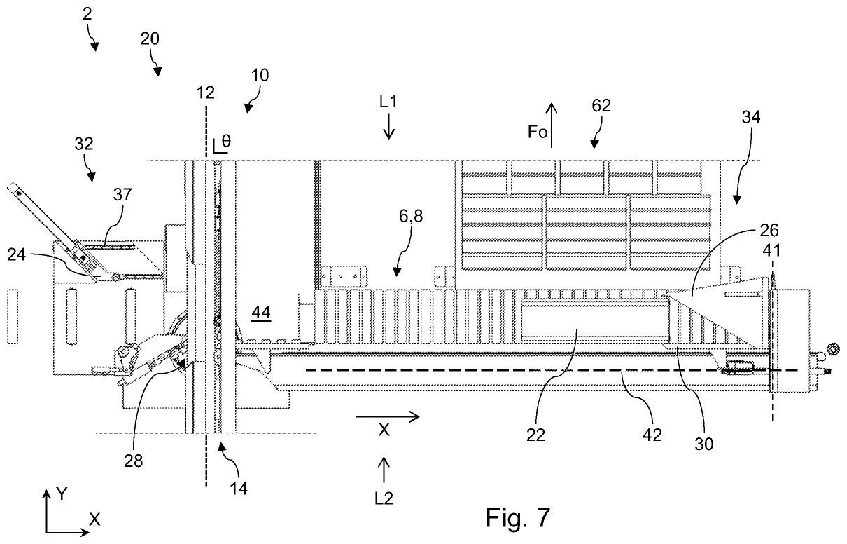

FIG. 7 shows a top view of part of a machining system, in particular a part associated with a sawing assembly;

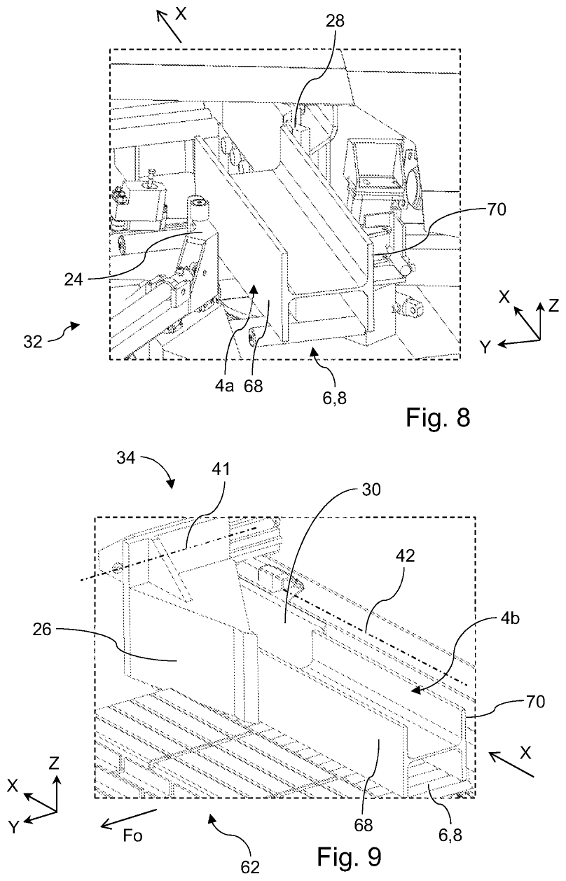

FIGS. 8 and 9 show perspective views of parts of a machining system, in particular corresponding to details of the part shown in FIG. 5;

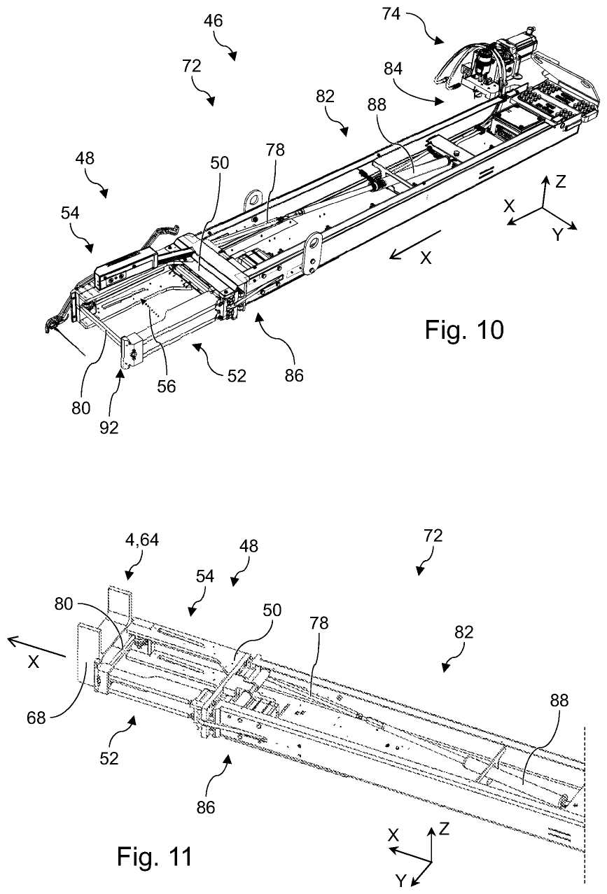

FIG. 10 shows a partially opened perspective view of a gripper truck assembly forming part of a machining system;

FIG. 11 shows a partially opened perspective view of part of a gripper truck assembly with a partially shown workpiece end section;

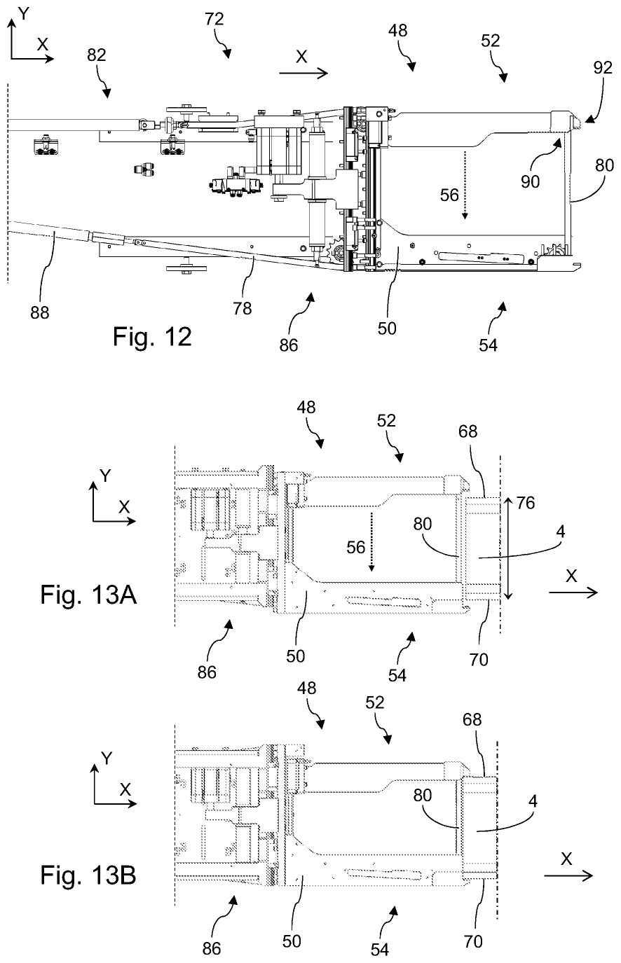

FIG. 12 shows a partially opened top view of part of a gripper truck assembly;

FIGS. 13A and 13B show partially opened top views of part of a gripper truck assembly with a partially shown workpiece end section, wherein the gripper assembly releases the workpiece end section in FIG. 13A and engages the workpiece end section in FIG. 13B; and

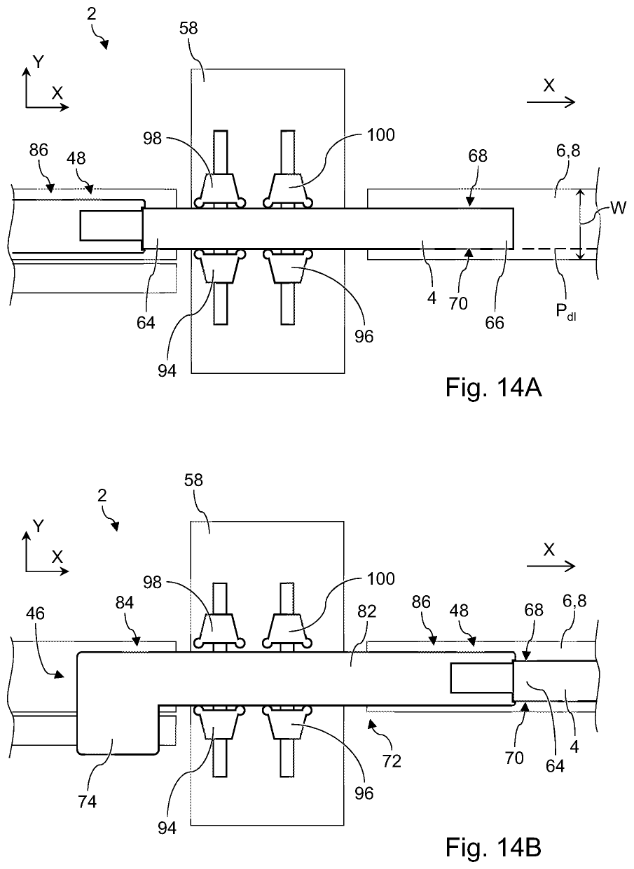

FIGS. 14A and 14B show top views of part of a machining system, in particular a part associated with a drilling assembly, with a gripper truck assembly, clamping elements and lateral limiting elements in different positions in FIG. 14B compared to FIG. 14A.

It shall be understood that the non-limiting examples shown throughout the various figures may be realized as part of a same common embodiment if desired, for example in an overall machining system and/or machining method. More generally, the skilled person having the benefit of the present disclosure, including the examples shown in the drawings, will appreciate how features shown throughout the various figures may be variously combined.

The figures, in particular FIGS. 1-9, show examples of a machining system 2 according to the first aspect for sawing a metal workpiece 4. The machining system 2 defines an orthogonal X-, Y-, Z-coordinate system of which an X-direction is horizontal, a Y-direction is horizontal and perpendicular to the X-direction and a Z-direction is vertical. The workpiece 4 has a workpiece main axis which is parallel to the X-direction, a first lateral outer side 68 and a second lateral outer side 70 which is opposite the first lateral outer side 68 both lateral outer sides 68, 70 extending parallel to the X-direction.

The machining system 2 according to the first aspect a conveying assembly 6 configured to convey the workpiece 4 thereon downstream along a transport path 8 in the X-direction with the second lateral outer side 70 extending in a vertical datum line plane Pai which is defined by the machining system 2 and extends in the X-direction. The workpiece 4 is at a frontside of the vertical datum line plane P_{dl}.

The machining system 2 according to the first aspect comprises a sawing assembly 10 arranged along the transport path 8 and configured to saw the workpiece 4 along a horizontal sawing path 12 (see e.g. FIGS. 3A, 3C, 5) which extends across the transport path 8 at a predetermined sawing angle θ with respect to the Y-direction. The sawing path 12 divides the workpiece 4 in an upstream workpiece section 4a and a downstream workpiece section 4b. The sawing assembly 10 comprises a band saw frame 14 which is rotatable with respect to the conveying assembly 6 about a vertical band saw frame rotation axis 16 so as to vary the predetermined sawing angle θ within a range of possible sawing angles ((see e.g. FIG. 3A and 4). The sawing angle range includes a negative sawing angle range Θ⁻ in which the band saw frame 14 extends from the saw frame rotation axis 16 across the transport path 8 in an area downstream from the band saw frame rotation axis 16 (See FIG. 3A and 4). The sawing angle ranges includes a positive sawing angle range Θ⁺ in which the band saw frame 14 extends from the saw frame rotation axis 16 across the transport path 8 in an area upstream from the band saw frame rotation axis 16. Finally, the sawing angle range includes a zero sawing angle in which the band saw frame 14 extends from the saw frame rotation axis 16 across the transport path 8 in the Y-direction.

The machining system 2 additionally comprises a downstream clamping assembly 34 (See FIGS. 4 and 5) having a first downstream clamping element 26 for laterally engaging the first lateral outer side 68 of the workpiece 4 and having a second downstream clamping element 30 for laterally engaging the second lateral outer side 70 of the workpiece 4. The downstream clamping assembly 34 is decoupled from the rotatability of the band saw frame 14. The first downstream clamping element 26 is moveable towards and away from the second downstream clamping element 30. This path for this movement is schematically indicated in the figures with dashed line 41. Both the first and the second downstream clamping element 26, 30 are moveably arranged in an upstream and a downstream direction along the X-direction see dashed lines 40, 42 for transporting a sawn-off workpiece section 4b away from the sawing assembly 10 in the downstream direction along the X-direction. The first downstream clamping element 26 is moveably arranged relative to the second downstream clamping element 30 in the upstream and the downstream direction along the X-direction (see dashed line 40).

In an embodiment, the machining system 2 may comprise:
an upstream clamping assembly 32 having a first upstream clamping element 24 for laterally engaging the first lateral outer side 68 of the workpiece 4 and having a second upstream clamping element 28 for laterally engaging the second lateral outer side 70 of the workpiece 4. In this embodiment, the upstream clamping assembly 32 is decoupled from the rotatability of the band saw frame 14. The first upstream clamping element 24 is movably arranged along a first horizontal clamping path 36 extending with clamping angle η1 relative to X-direction. The first upstream clamping element 24 is additionally moveably arranged upstream and a downstream along a path 37 parallel to the X-direction X.

The advantages associated with the machining system according to the first aspect and the embodiment thereof have been described in the summary section and are incorporated here by reference.

To provide an overview of the flow of elongated workpieces 4 through the machining system 2 reference is made to FIG. 1. Here infeed area 60 is a buffer for elongated profiles which can be supplied in an infeed direction Fᵢ to the conveying assembly 6. The conveying assembly 6 supplies the unmachined elongated profiles to an optional first machining assembly 58, e.g. a drilling assembly, a milling assembly, a marking assembly or similar, and subsequently to a sawing assembly 10 which may be a miter saw. In the sawing assembly 10, the elongated profiles are sawn into separate workpieces 4 which are conveyed by the conveying assembly 6 in a downstream direction along the X-direction. Subsequently, the workpieces may be transported in an outfeed direction Fₒ to an outfeed area 62. One of the objects is that the machining system 2 is operated as much as possible without human intervention, i.e. in an automated manner.

In an embodiment of the machining system, the downstream clamping assembly 34 is the active clamping assembly when the first and the second lateral outer sides 68, 70 of the downstream workpiece section 4b are long enough to firmly clamp the downstream workpiece section 4b with the first and second downstream clamping elements 26, 30. A position of the first downstream clamping element 26 is within a distance of less than 20 mm, more preferably less than 10 mm of the sawing path 12 when the sawing angle θ of the sawing path 12 is within the negative sawing angle range Θ⁻. A position of the first downstream clamping element 26 is perpendicularly opposite the second downstream clamping element 30 when the sawing angle θ of the sawing path 12 is zero or is within the positive sawing angle range Θ⁺.

In an embodiment of the machining system, the upstream clamping assembly 32 is the active clamping assembly, when at least one of the first and the second lateral outer sides 68, 70 of the downstream workpiece section 4b is too short to firmly clamp the downstream workpiece section 4b with the first and second downstream clamping elements 26, 30. A position of both the first upstream clamping element 24 and the second upstream clamping element 28 are within a distance of less than 20 mm, more preferably less than 10 mm of the sawing path 12 when the sawing angle θ of the sawing path 12 is within the positive sawing angle range Θ⁺. A position of the first upstream clamping element 24 is perpendicularly opposite the second upstream clamping element 28 when the sawing angle θ of the sawing path 12 is zero or is within the negative sawing angle range Θ⁻.

Thus, the stability of the workpiece during the sawing is optimally ensured.

In an embodiment, the clamping angle η1 of the horizontal clamping path 36 along which the first upstream clamping element 24 is moveable is relative to the X-direction is in the range of 10° to 80°, preferably in the range of 15° to 70°, more preferably in the range of 20° to 60°, more preferably in the range of 25° to 50°, for example about 30° or about 45°. Thus, it may be accomplished that, even when the first upstream clamping element 24 is positioned close to the sawing path 12, the first horizontal clamping path 36 does not interfere with the sawing path 12 even when the sawing angle θ is in the positive extreme of the positive sawing angle range Θ⁺.

In an embodiment, the second upstream clamping element 28 is movably arranged along a second horizontal clamping path 38 extending with clamping angle η2 relative to X-direction, the clamping angle η2 being in the range of 10° to 80°, preferably in the range of 15° to 70°, more preferably in the range of 20° to 60°, more preferably in the range of 25° to 50°, for example about 30° or about 45°. Thus, it may be accomplished that the second clamping path 38 does not interfere with the sawing path 12 even when the sawing angle θ is in the negative extreme of the negative sawing angle range Θ⁻. The advantages of the moveability of the second upstream clamping element 28 along the second clamping path 38 provides advantages which will be described further below with reference to subsequent embodiments and which relate to the possibility to be able to move a gripper head 48 of a gripper assembly downstream along and optionally even beyond the first and the second upstream clamping elements 24, 28.

In an embodiment, the conveying assembly 6 comprises a passage 44 at the sawing assembly 10 through which passage 44 a sawn off workpiece section can fall for removal thereof, at least when the sawn off workpiece section is small compared to the passage 44. The passage may, e.g. have a length in the X-direction of 500 mm. With such a dimension, it is expected that more than 95% of the workpiece parts which can not be transported away in the downstream direction with the downstream clamp assembly 34 can removed from the sawing assembly 10.

In an embodiment, the machining system 2 may further comprise a gripper truck assembly 46 for transporting the workpiece 4 in the X-direction. The gripper truck assembly 46 comprises a gripper head 48 which comprises a gripper head main body 50 having a first jaw 52 and a second jaw 54 for engaging two opposite lateral outer sides 68, 70 of the workpiece 4 which each extend in a respective vertical plane. The first jaw 52 is configured to be translationally actuatable with respect to the second jaw 54 along a jaw translation path 56 which extends parallel to the Y-direction for thereby engaging one of the opposite lateral outer sides 68, 70.

Advantages and optional elaborations of such a gripper truck assembly 46 are explained elsewhere herein, in particular in the context of the third to seventh aspects.

In a further elaboration of this embodiment with gripper truck assembly 46, the machining system 2 additionally comprises a support roller assembly 201 which is positioned upstream of the second upstream clamping element 28 and which is configured for supporting either the workpiece 4 or the gripper head 48 of the gripper truck assembly 46.

The support roller assembly 201 prevents rotation of the workpiece 4 around a vertical pivot axis which may be formed by the contact point of the second upstream clamping element 28 and the workpiece 4, for example when the first upstream clamping element 24 is not engaging the workpiece 4 perpendicularly opposite said contact point. This will be the case when the saw path 12 is extending in the negative sawing angle range Θ⁻.

In a further elaboration, the support roller assembly 201 may comprise a static roller 203 which is rotatable around a vertical axis and of which a circumferential roller surface is positioned at a backside of the vertical datum line plane P_{dl} at a distance from the vertical datum line plane P_{dl}. The static roller 203 is configured to support the gripper head 48 when the gripper head 48 is moved downstream in the X-direction beyond the static roller 203. The support roller assembly 201 may additionally comprise a pivoting roller 205 which is rotatable around a vertical axis and of which the vertical axis is positionable at a first and a second position. A circumferential roller surface of the pivoting roller 205 is tangentially aligned with the vertical datum line plane P_{dl} when being in the first position so as to engage and support the workpiece 4. The circumferential roller surface of the pivoting roller 205 is at a backside of the vertical datum line plane P_{dl} at a distance from the vertical datum line plane P_{dl} so as to allow to pass the gripper head 48 when the gripper head 48 is moved downstream in the X-direction beyond the pivoting roller 205.

In order to be able to allow to pass the gripper head 48 even beyond the second downstream clamping element 28, in an embodiment of the machining system 2 the second upstream clamping element 28 may be movable away from the vertical datum line plane P_{dl} at the backside of the vertical datum line plane P_{dl} at a distance from the vertical datum line plane P_{dl} 4 so as to provide space for the second jaw 54 of the gripper head 48 to move along the second upstream clamping element 28 in the X-direction. See in this respect FIG. 3B. Subsequently, the second upstream clamping element 28 in a clamping position is moved towards the second lateral outer side 70 of the workpiece 4 against the second jaw 54 of the gripper head 48 so that second jaw 54 is interposed between the workpiece 4 and the second upstream clamping element 28 and the clamping force of the first upstream clamping element 24 is transferred via first jaw 52 of the gripper head 48, the workpiece 4, and the second jaw 54 of the gripper head 48 to the second clamping element 28. Thus, the workpiece 4 is stabilized by the upstream clamping assembly 32 even though the second upstream clamping element 28 does not directly engage the workpiece 4 but, instead, the second jaw 54 of the gripper head 54. This situation is shown in FIG. 3C. By virtue thereof, even a very short upstream workpiece section 4a see FIG. 3C can be sawn off from the downstream workpiece section 4b also when the sawing path angle θ is in the positive sawing angle range Θ. In other words, the upstream clamping assembly 32 advantageously allows the jaws 52, 54 of the gripper head 48 to move relatively close to the sawing path 12, while an upstream workpiece section 4a is clamped by the jaws 52, 54 e.g. for transport along the X-direction. For stable sawing, the first and second upstream clamping elements 24, 28 engage the jaws 52, 54, and thereby indirectly the workpiece 4. This allows the workpiece 4 to be positioned and stabilized with the sawing path 12 particularly close to a trailing end of the workpiece 4.

In an embodiment of the machining system 2, the negative sawing angle range Θ⁻ may extend from −70° to 0°, preferably from −60° to 0°. The positive sawing angle range θ⁺ extends from 0° to 60°, preferably from 0° to 45°. When the negative and positive angle ranges extend within these limits the majority of the desired distal and proximal end configurations of the workpiece 4 can be formed.

The figures, in particular FIGS. 1-6, also illustrate a method according to the second aspect of sawing a metal workpiece 4 having a workpiece main axis, a first lateral outer side 68 and a second lateral outer side 70 which is opposite the first lateral outer side 68. The method comprises:
providing a machining system 2 according to the first aspect;
conveying the workpiece 4 on the conveying assembly 6 along the transport path 8 in the X-direction to the sawing assembly 10 with the workpiece main axis parallel to the X-direction and the second lateral outer side 70 extending in the vertical datum line plane P_{dl} and the workpiece 4 being at a frontside of the vertical datum line plane P_{dl};
using the downstream clamping assembly 34 when the sawing angle θ of the band saw frame 14 is zero or is within the negative sawing angle range Θ⁻, wherein the using includes positioning at least the first downstream clamping element 26 along the X-direction so as to be within a predetermined distance from a sawing path 12, wherein predetermined distance is less than 20 mm, preferably less than 10 mm, and moving the first downstream clamping element 26 towards the second downstream clamping element 30 to clamp a downstream workpiece section 4b of the workpiece 4;
using the sawing assembly 10 during the clamping of the downstream workpiece section 4b to saw off the downstream workpiece section 4b; and
transporting the downstream workpiece section 4b which has been sawn-off away from the sawing assembly 10 downstream along the X-direction by simultaneously moving the first and the second downstream clamping elements 26, 30 downstream along the X-direction.

FIG. 4 shows a top view of the use of the downstream clamping assembly 34 with the saw path 12 extending in the negative sawing angle range Θ⁻. It is clear that both the first downstream clamping element 26 as well as the second downstream clamping element 30 are positioned along the X-direction such that they are both clamping the downstream workpiece section 4b very close to the sawing path 12. This leads to a very stable clamping of the workpiece 4 close to the sawing path 12 and thus to a very neat saw cut.

In fact, there may be an exception to positioning the first and/or the downstream clamping elements 26, 30 as close as possible to the saw path 12, and that is when the upstream end of the downstream workpiece section 4b, or alternatively the downstream end of the upstream workpiece section 4a has to be provided with a configuration which requires multiple saw cuts. An example of such a configuration is shown in FIG. 5d in which the upstream end of a downstream workpiece section 4c is formed by three saw cuts. FIGS. 5a, 5b and 5c show the positions of the first and second downstream clamping elements 26, 30 relative to the saw path 12 when making the first, the second and the third saw cut. In FIG. 5a, the first downstream clamping element 26 is position as close as possible to the sawing path 12, whereas the second downstream clamping element 30 is positioned at a distance from the sawing path 12. Subsequently, in FIG. 5b, the sawn off downstream workpiece section 4b has been moved a little to the left by movement of both the first and the second downstream clamping elements 26, 30 to the left. The sawing path 12 now extends parallel to the Y-direction and the both the first and the second downstream clamping element 26, 30 are positioned at a distance from the sawing path 12. Then the small triangular upstream workpiece section 4a is sawn off. Finally, again both the first and the second downstream clamping elements 26, 30 are moved to the left together with the downstream workpiece section 4b up to a point that the second downstream clamping element 30 is positioned as close as possible to the sawing path 12 which now extends at a sawing angle θ which is in the positive sawing angle range θ⁺. Then the third saw cut is made and a second small triangular upstream workpiece section 4a is sawn off so that the downstream workpiece section 4c has obtained the configuration which is shown in FIG. 5d.

In an embodiment, in which the machining system includes the upstream clamping assembly 32 as described above, the method comprises:
using the upstream clamping assembly 32 when the sawing angle θ of the band saw frame 14 is within the positive sawing angle range Θ⁺, wherein the using includes positioning at least the first upstream clamping element 24 along path 37 parallel to the X-direction so as to be within a predetermined distance from a sawing path 12 during the actual clamping, wherein predetermined distance is less than 20 mm, preferably less than 10 mm, and moving the first upstream clamping element 24 along the first horizontal clamping path 36 towards the second upstream clamping element 28 to clamp an upstream workpiece section 4a of the workpiece 4;
using the sawing assembly 10 during the clamping of the upstream workpiece section 4a to saw off the downstream workpiece section 4b.

The movements of the first upstream clamping element 24 along path 37 and along first horizontal clamping path 36 may be performed subsequently to each other but, in an embodiment, the movements may also be performed simultaneously so as to be able to move first upstream clamping element 24 as close as possible to the sawing path 12 at the moment the actual engagement between first upstream clamping element 24 and the upstream workpiece section 4a or alternatively the gripper head 48 occurs.

Due to the fact that the first and second upstream clamping elements 24, 28 are positioned as close as possible to the sawing path 12 when the sawing angle θ is within the positive sawing angle range Θ⁺, the upstream workpiece section 4a is gripped firmly and stable close to sawing path 12 so that a very neat saw cut will be obtained.

In an embodiment of the method according to the second aspect, during clamping of the upstream workpiece section 4a by the upstream clamping assembly 32, the downstream clamping assembly 34 is not clamping the downstream workpiece section 4b and vice versa.

By thus avoiding clamping at both sides of the sawing path 12, it can be prevented that the workpiece section is strained at the sawing path 12, which could otherwise potentially hamper the sawing.

When the sawing path 12 extended in the positive sawing angle range Θ⁺ and the upstream clamping assembly 32 was active, in an embodiment, after sawing off the downstream workpiece section 4b, the downstream clamping assembly may be activated to clamp the sawn-off downstream workpiece section 4b and may be subsequently controlled to transport the downstream workpiece section 4b downstream along the X-direction.

Thus an automated operation of the machining system 2 without human interference is possible.

When the machining system 2 is in accordance with an embodiment having a gripper truck assembly 46 as described above, an embodiment of the method may comprise adjusting the position of the second upstream clamping element 28 away from the vertical datum line plane P_{dl} at the backside of the vertical datum line plane P_{dl} at a distance from the vertical datum line plane P_{dl} 4 so as to provide space for the second jaw 54 of the gripper head 48 to move along the second upstream clamping element 28 in the transport direction T. The method of this embodiment may further comprise subsequently moving the second upstream clamping element 28 in a clamping position by moving towards the second lateral outer side 70 of the workpiece 4 against the second jaw 54 of the gripper head 48 so that second jaw 54 is interposed between the workpiece 4 and the second upstream clamping element 28 and the clamping force of the first upstream clamping element 24 is transferred via first jaw 52 of the gripper head 48, the workpiece 4, and the second jaw 54 of the gripper head 48 to the second clamping element 28.

Thus, it is possible to make a saw cut very close to the upstream end of the downstream workpiece section 4b even when the sawing angle θ is in the positive sawing angle range Θ. Thus, loss of workpiece material may be minimalized and very short workpieces may be produced.

When the machining system 2 is in accordance with an embodiment having the support roller assembly 201 with the static roller 203 and the pivoting roller 205 as described above, the method may in an embodiment comprise adjusting the position of the pivoting roller 205 from the first position to the second position so as to allow the gripper head 48 to pass the pivoting roller 205 when the gripper head 48 is moved downstream in the X-direction beyond the pivoting roller 205.

The figures, in particular FIGS. 1, 3A-C, and 8 to 12B, also illustrate a method according to the third aspect of transporting an elongate metal workpiece 4 with respect to a machining station 10, 58. The machining station may be a sawing assembly 10 as extensively described above. Additionally, or alternatively, the machining station may be a drilling assembly 58 with which holes may be drilled in the workpiece 4. Other types of machining stations are also feasible, e.g. a milling station and/or a marking station. The machining station 10, 58 defines a orthogonal X,Y,Z-coordinate system of which an X-direction is horizontal, a Y-direction is horizontally extending perpendicular to the X-direction and a Z-direction is vertical. The elongate workpiece 4 has a workpiece main axis substantially parallel to the X-direction and extending between a first 64 and a second 66 workpiece axial end, the workpiece 4 having two lateral opposite outer sides 68, 70 each extending in a respective vertical plane extending parallel to the X- and Z-directions.

According to the third aspect, the method comprises: gripping the elongate workpiece 4 at the first workpiece axial end 64 by a gripper assembly 72 extending along the X-direction from a gripper truck 74; and while the workpiece 4 continues to be gripped by the gripper assembly 72, driving the gripper truck 74 to thereby transport the workpiece 4 in the X-direction with respect to the machining station 10, 58.

According to the third aspect, the gripping comprises, by the gripper assembly 72, engaging the opposite lateral outer sides 68, 70 of the workpiece 4 at the first workpiece axial end 64.

FIGS. 1, 3A-C, and 10 to 14B also show a gripper assembly 72 according to the fourth aspect for gripping an elongate metal workpiece 4 for transporting the elongate workpiece 4 with respect to a machining station 10, 58. The machining station 10, 58 defines an orthogonal X,Y,Z-coordinate system of which an X-direction is horizontal, a Y-direction is horizontally extending perpendicular to the X-direction and a Z-direction is vertical. The elongate workpiece 4 has a workpiece main axis substantially parallel to the X-direction and extending between a first 64 and a second 66 workpiece axial end. The workpiece 4 has two lateral opposite outer sides 68, 70 each extending in a respective vertical plane extending parallel to the X- and Z-directions.

According to the fourth aspect, the gripper assembly 72 comprises an elongate gripper arm 82 having a gripper arm main axis and extending between a gripper arm proximal end 84 and a gripper arm distal end 86, the gripper arm 82 being configured to connect to the gripper truck 74 at the gripper arm proximal end 84 with the gripper arm main axis substantially parallel to the X-direction.

According to the fourth aspect, the gripper assembly 72 comprises a gripper head 48 connected to the gripper arm 82 at the gripper arm distal end 86 and configured to grip the workpiece 4 at the first workpiece axial end 64 which faces the gripper assembly 72. For the gripping of the workpiece 4, the gripper head 48 is configured to engage the opposite lateral outer sides 68, 70 of the workpiece 4 at the first workpiece axial end 64.

FIGS. 1, 3A-C, and 10 to 14B also show a gripper truck assembly 46 according to the fifth aspect for transporting an elongate workpiece 4 in an X-direction with respect to a machining station 10, 58. The elongate workpiece 4 has a workpiece main axis substantially parallel to the X-direction and extending between workpiece axial ends 64, 66.

According to the fifth aspect, the gripper truck assembly 46 comprises: a gripper assembly 72 according to the fourth aspect; and a gripper truck 74 which is drivable along the X-direction.

According to the fifth aspect, the gripper arm 82 of the gripper assembly 72 is connected to the gripper truck 74 at the gripper arm proximal end 84 with the gripper arm main axis substantially parallel to the transport X-direction.

The figures also show a machining system 2 according to the sixth aspect for machining an elongate metal workpiece 4. Again, the machining system 2 defines an orthogonal X, Y,Z-coordinate system of which an X-direction is horizontal, a Y-direction is horizontal direction extending perpendicular to the X-direction and a Z-direction is vertical. The elongate metal workpiece 4 again has a workpiece main axis and extends between workpiece axial ends 64, 66 and being parallel to the X-direction. The workpiece 4 has two lateral opposite outer sides 68, 70 each extending in a respective vertical plane extending parallel to the X- and Z-directions.

According to the sixth aspect, the machining system 2 comprises: a gripper truck assembly 46 according to the fifth aspect; and a machining station 10, 58 configured to machine the workpiece 4 while the workpiece 4 is gripped by the gripper assembly 72 of the gripper truck assembly 46, at a machining position along the workpiece main axis which is dependent on a transporting of the workpiece 4 with respect to the machining station 10, 58 by the gripper truck assembly 46.

Preferably, the machining system 2 comprises at least two such machining stations at mutually different positions along the X-direction, for example a first machining station corresponding to a drilling station 58 and a second machining station corresponding to a sawing assembly 10. In the shown examples, the second machining station 10 is arranged downstream from the first machining station 58, but this could be the other way around.

The figures also illustrate a method according to the seventh aspect of machining an elongate metal workpiece 4 having a workpiece main axis and extending between workpiece axial ends 64, 66, the method comprising: providing a machining system 2 according to the sixth aspect; using the gripper truck assembly 46 of the machining system 2, transporting the workpiece 4 with respect to the machining station 10, 58 of the machining system 2; and during and/or after at least some of the transporting, machining the workpiece 4 at the machining station 10, 58 of the machining system 2.

In embodiments, in particular embodiments according to the third aspect, a workpiece transverse width 76 defined between the opposite lateral outer sides 68, 70 at the first workpiece axial end 64 is at least 30 mm, preferably at least 40 mm, more preferably at least 50 mm, for example about 60 mm or more.

Thus, workpieces of various sizes, including relatively wide workpieces, may be transported.

In embodiments, in particular embodiments according to the third aspect, the engaging of the opposite lateral outer sides 68, 70 comprises translationally actuating at least one jaw 52 of the gripper assembly 72 substantially in the Y-direction towards one 68 of the opposite lateral outer sides.

In embodiments, in particular embodiments according to the fourth aspect, the gripper head 48 comprises a gripper head main body 50 and at least one jaw 52 which is configured to be translationally actuatable with respect to the gripper head main body 50 along a jaw translation path 56 which extends substantially parallel to the Y-direction for thereby engaging one 68 of the opposite lateral outer sides.

Thereby a range of gripping widths can be provided in a relatively simple and robust way, wherein in particular the translation path can promote reliable gripping of the lateral outer sides. It has been found that such translational actuation can provide particularly reliable gripping, in particular for relatively wide workpieces. In known methods, jaw actuation of a gripper assembly is rotational rather than translational.

In embodiments, in particular embodiments according to the third aspect, the engaging comprises, in the gripper assembly 72, tensioning a chain 78, cable, or belt of which at least a section 80 extends substantially in the Y-direction and is arranged adjacent the first workpiece axial end 64, wherein adjacent is defined as at a distance of less than 100 mm.

In embodiments, in particular embodiments according to the fourth aspect, the gripper assembly 72 comprises a chain 78, cable, or belt configured to connect the jaw 52 to a jaw actuator 88 for the translational actuation, the chain 78, cable, or belt being connected to the jaw 52 at a chain, cable, or belt connecting position 90 which is near, but at a distance from, a distal end 92 of the jaw 52, wherein the distance between the connecting position 90 and the distal end 92 is in a range of 2-100 mm.

In this way, a reliable translational actuation can be provided, in particular with limited moments acting on jaws 52, 54 when the jaws 52, 54 close onto the workpiece 4.

In embodiments, in particular embodiments according to the third aspect, the method further comprises, while the workpiece 4 continues to be gripped by the gripper assembly 72, allowing, by the gripper assembly 72, the first workpiece axial end 64 to move with respect to the gripper truck 74 by a predetermined maximum distance in the Y-direction.

In embodiments, in particular embodiments according to the fourth aspect, the gripper head 48 is movably connected to the gripper arm 82 to allow the gripper head 48 to move with respect to the gripper arm 82 over a predetermined maximum distance substantially in the Y-direction together with the first workpiece axial end 64, while the workpiece 4 continues to be gripped by the gripper head 48.

When a workpiece is for example slightly curved as opposed to being perfectly straight along its main axis, such an allowed movement of the first workpiece axial end 64 can help to avoid unwanted tension and/or lateral movement elsewhere along the workpiece main axis, in particular at a machining station. Meanwhile, by imposing the predetermined maximum distance, excessive lateral deviations can be prevented. In particular, some workpieces, in particular lighter workpieces, may even be forced towards a straighter shape, thereby enabling a more precise machining.

In an embodiment, the gripper head 48 may be spring loaded in a preferred position in the Y-direction which preferred position is a neutral position. This may limit movement of a light workpiece in the Y-direction long before the end of the movement range of the gripper in Y-direction is reached.

In embodiments, in particular embodiments according to the third aspect, the predetermined maximum distance is at least 20 mm, preferably at least 30 mm, more preferably at least 40 mm.

In this way, relatively large lateral deviations of the first workpiece axial end can be accommodated.

In embodiments, in particular embodiments according to the fourth aspect, the gripper head 48 is configured to provide a range of gripping widths corresponding to an engageable range of workpiece transverse widths 76 defined between the opposite lateral outer sides 68, 70 at the first workpiece axial end 64.

Thus, workpieces of various widths may be gripped and transported.

In embodiments, in particular embodiments according to the fourth aspect, the range of gripping widths has an upper limit, the upper limit being at least 60 mm, preferably at least 80 mm, more preferably at least 160 mm, more preferably at least 240 mm, for example about 300 mm.

Thereby, workpieces may be gripped and transported which are relatively wide, while the presence of the upper limit still allows the gripper assembly to be relatively compact.

The figures also show a machining system 2 according to the eighth aspect, wherein the machining system 2 again defines an orthogonal X,Y,Z-coordinate system of which an X-direction is horizontal, a Y-direction is horizontally extending perpendicular to the X-direction and a Z-direction is vertical. The machining system 2 according to the eighth aspect is configured for machining an elongate metal workpiece 4 having a workpiece main axis extending in the X-direction. The workpiece 4 has a first lateral outer side 68 and an opposite second lateral outer side 70 each extending in a respective vertical plane extending parallel to the X- and Z-directions.

According to the eighth aspect, the machining system 2 comprises: a conveying assembly 6 extending in the X-direction and configured for conveying the workpiece 4 thereon along the X-direction. At least one machining station 10, 58 is arranged along the conveying assembly 6 and configured to machine the workpiece 4 while the workpiece 4 is on the conveying assembly 6. The machining station 2 comprises at least one clamping element 24, 26, 98, 100 for clamping the workpiece 4 at the first lateral outer side 68. Additionally, the machining system 2 comprises one or more lateral limiting elements 28, 30, 94, 96 configured to limit a position of the workpiece 4 on the conveying assembly 6 to a predetermined lateral limit by engagement of the second lateral outer side 70 of the workpiece 4. In fact, the predetermined lateral limit defines a vertical datum line plane P_{dl} that extends parallel to the X- and Z-directions. The machining system 2 is configured to position the workpiece 4 such that the second lateral side 70 thereof extends in the vertical datum line plane P_{dl}.

According to the eighth aspect, the one or more lateral limiting elements 28, 94, 96 are adjustable between a limiting state and a permitting state, wherein in the limiting state the lateral limiting element 28, 94, 96 is configured to limit the position of the workpiece 4 on the conveying assembly 6 to the predetermined lateral limit at the respective lateral limiting element 28, 30, 94, 96, wherein in the permitting state the lateral limiting element 28, 30, 94, 96 is configured to permit one or more objects on the conveying assembly 6 to extend beyond the predetermined lateral limit at the respective lateral limiting element 28, 94, 96.

The figures also illustrate a method according to the ninth aspect of machining an elongate metal workpiece 4 having a workpiece main axis. The method comprises:

providing a machining system 2 according to the eighth aspect;

conveying the workpiece 4 on the conveying assembly 6 along the transport direction T with respect to the machining station 10, 58 with the workpiece main axis substantially parallel to the transport direction T, wherein, during the conveying, at least one of the one or more lateral limiting elements 28, 94, 96 is adjusted between the limiting state and the permitting state; and

after and/or during at least some of the conveying, machining the workpiece at the machining station 10, 58 while the workpiece 4 is on the conveying assembly 6.

In embodiments, in particular embodiments according to the eighth aspect, the predetermined lateral limit extends in a vertical datum line plane P_{dl} which extends parallel to the X- and Z-directions in which the second lateral side 70 of the workpiece 4 extends. The machining station 2 is configured to use the vertical datum line plane P_{dl} as a positional reference for machining of the workpiece 4.

In this way, it can be promoted that the workpiece 4 is positioned in conformity with vertical datum line plane P_{dl}, in turn promoting accurate machining on the workpiece 4 by a machining station 10, 58.

In embodiments, in particular embodiments according to the eighth aspect, at least one of the one or more lateral limiting elements 28, 94, 96 is movable between a limiting position and a permitting position to adjust the lateral limiting element 28, 94, 96 between the limiting state and the permitting state, wherein in the limiting position the lateral limiting element 28, 94, 96 is in the limiting state, wherein in the permitting position the lateral limiting element 28, 94, 96 is in the permitting state.

Such movability can relatively simply yet effectively provide such adjustment between the limiting state and the permitting state.

In embodiments, in particular embodiments according to the eighth aspect, in the limiting position the lateral limiting element 28, 94, 96 is arranged laterally at the predetermined lateral limit, wherein in the permitting position the lateral limiting element 28, 94, 96 is arranged laterally beyond and spaced apart from the predetermined lateral limit.

Thus, a movement to adjust a lateral limiting element between the limiting state and the permitting state can be a substantially lateral movement, so that the second lateral side 70 of the workpiece 4 and/or the gripper assembly 72 can be approached and/or departed from gradually, thereby promoting a smooth and robust operation.

In embodiments, in particular embodiments according to the eighth aspect, the limiting position and the permitting position are mutually different along the transport direction T, at least for one 28 of the one or more lateral limiting elements.

For example, FIGS. 3A-C show an example of an embodiment in which a first lateral limiting element is embodied as the second upstream clamping element 28. The movement of this first lateral limiting element 28 between the limiting position (e.g. FIG. 3A) and the permitting position (e.g. FIG. 3B) is along a path 38 which extends at a non-right angle to the X-direction, so that it has components both along and transverse to the X-direction. Such an arrangement may be particularly advantageous at a sawing assembly 10, in particular with a rotatable sawing path 12 as explained elsewhere herein.

In embodiments, in particular embodiments according to the eighth aspect, the machining system 2 is configured to move the lateral limiting element 28 along a predetermined movement path 38 between the limiting position and the permitting position, wherein the predetermined movement path extends at an angle η2 to the X-direction in the range of 10° to 80°, preferably in the range of 20° to 70°, more preferably in the range of 30° to 60°.

With particular reference to FIG. 3A, such an angle η2 may advantageously conform to a possible sawing angle θ, so that the lateral limiting element 28 can act close to a sawing path 12.

In embodiments, in particular embodiments according to the eighth aspect, with respect to the transport direction T, at least one of the one or more lateral limiting elements 28, 94, 96 is arranged at a workpiece clamping position associated with the at least one clamping element 24, 98, 100 of the machining station 10, 58. In the examples shown in the figures, one of the limiting elements 28 is formed by the second upstream clamping element 28 of the sawing assembly 10. See in this respect FIGS. 3A-3C and FIG. 4. The other two lateral limiting elements 94, 96 may, as shown in FIGS. 14A and 14B, be associated with the other machining assembly 58 which may be a drilling assembly, a milling assembly, a marking assembly or another type of machining assembly. Those two lateral limiting elements 94, 96 associated with the other machining assembly 58 are also clamping elements which are configured for engaging the second lateral side 70 of the workpiece 4.

With reference to FIGS. 3A-C, 4 and 14A-B, the lateral limiting elements 28, 94, 96 in such a case may additionally provide a clamping function, in particular in collaboration with the first upstream clamping element 24 of the sawing assembly 10, and with clamping element 98, 100 of the other machining assembly. These clamping elements 24, 98, 100 may be arranged at an opposite side of the workpiece 4 during use and during clamping engage the first lateral side 68 of the workpiece 4.

In embodiments, in particular embodiments according to the eighth aspect, at the workpiece clamping position, the at least one clamping element 24, 98, 100 is configured to clamp the workpiece 4 between the lateral limiting element 28, 94, 96 and the clamping element 24, 98, 100, for thereby fixating at least a transverse position of the workpiece 4 during machining in the machining station 10, 58.

Advantages and possible elaborations of such clamping elements are explained elsewhere herein and can thus be advantageously combined with such lateral limiting elements. In view of the present description and the drawings, it shall be appreciated that a lateral limiting element may be, comprise and/or be formed by a clamping element, and/or vice versa.

Although the invention has been explained herein using examples of embodiments and drawings, these do not limit the scope of the invention as defined by the claims. Many variations, combinations and extensions are possible, as will be appreciated by the skilled person. All such variants are included within the scope of the invention as defined by the claims.

### List of Reference Signs

2. Machining system
4. Workpiece
4a. Upstream workpiece section
4b. Downstream workpiece section
6. Conveying assembly
8. Transport path
10. Sawing assembly, Second machining station
12. Sawing path
14. Band saw frame
16. Band saw frame rotation axis
18. Sawing range
24. First upstream clamping element
26. First downstream clamping element
28. Second upstream clamping element, First lateral limiting element
30. Second downstream clamping element
32. Upstream clamping assembly
34. Downstream clamping assembly
36. Positioning path first upstream clamping element
37. Positioning path first upstream clamping element parallel to X-direction
38. Positioning path second upstream clamping element
40. Positioning path first downstream clamping element relative to the second downstream clamping element
41. Movement path first downstream clamping element
42. Positioning path second downstream clamping element optionally together with the first downstream clamping element
44. Passage
46. Gripper truck assembly
48. Gripper head
50. Gripper head main body
52. First jaw
54. Second jaw
56. Jaw translation path
58. Drilling assembly, First machining station
60. Infeed area
62. Outfeed area
64. First workpiece axial end
66. Second workpiece axial end
68. First lateral outer side of workpiece
70. Second lateral outer side of workpiece
72. Gripper assembly
74. Gripper truck
76. Workpiece transverse width
78. Chain
80. Chain section
82. Gripper arm
84. Gripper arm proximal end
86. Gripper arm distal end
88. Jaw actuator
90. Chain connecting position
92. Distal end of first jaw
94. Second lateral limiting element
96. Third lateral limiting element
98. Third clamping element
100. Fourth clamping element
P_{dl}. Vertical datum line plane
W. Transport path width
X. X-direction
Y. Y-direction
Z. Z-direction
θ. Sawing angle
Θ. Range of possible sawing angles
η1, η2. Clamping angles
Fi. Infeed direction of elongated profiles
Fo. Outfeed direction of sawn-off workpieces

1. A machining system for sawing a metal workpiece, the machining system defining an orthogonal X-, Y-, Z-coordinate system of which an X-direction is horizontal, a Y-direction is horizontal and perpendicular to the X-direction and a Z-direction is vertical, the workpiece having a workpiece main axis parallel to the X-direction, a first lateral outer side and a second lateral outer side opposite the first lateral outer side, both the first and the second lateral outer sides extending parallel to the X-direction, wherein the machining system comprises:
a conveying assembly configured to convey the workpiece thereon downstream along a transport path in the X-direction with the second lateral outer side extending in a vertical datum line plane defined by the machining system and extending in the X-direction, the workpiece being at a frontside of the vertical datum line plane;
a sawing assembly arranged along the transport path and configured to saw the workpiece along a horizontal sawing path extending across the transport path at a predetermined sawing angle with respect to the Y-direction, wherein the sawing path divides the workpiece into an upstream workpiece section and a downstream workpiece section, the sawing assembly comprising a band saw frame rotatable with respect to the conveying assembly about a vertical band saw frame rotation axis so as to vary the predetermined sawing angle within a range of possible sawing angles comprising:
a negative sawing angle range in which the band saw frame extends from the vertical band saw frame rotation axis across the transport path in an area downstream from the vertical band saw frame rotation axis;
a positive sawing angle range in which the band saw frame extends from the vertical band saw frame rotation axis across the transport path in an area upstream from the vertical band saw frame rotation axis; and
a zero sawing angle in which the band saw frame extends from the vertical band saw frame rotation axis across the transport path in the Y-direction;
and wherein the machining system additionally comprises:
a downstream clamping assembly having a first downstream clamping element for laterally engaging the first lateral outer side of the workpiece and having a second downstream clamping element for laterally engaging the second lateral outer side of the workpiece;
wherein the downstream clamping assembly is decoupled from the rotatability of the band saw frame;
wherein the first downstream clamping element is moveable towards and away from the second downstream clamping element;
wherein both the first downstream clamping element and the second downstream clamping element are moveably arranged in an upstream direction and a downstream direction along the X-direction for transporting a sawn-off workpiece section away from the sawing assembly in the downstream direction along the X-direction; and
wherein the first downstream clamping element is moveably arranged relative to the second downstream clamping element in the upstream direction and the downstream direction along the X-direction.

2. The machining system according to claim 1, further comprising:
an upstream clamping assembly having a first upstream clamping element for laterally engaging the first lateral outer side of the workpiece and having a second upstream clamping element for laterally engaging the second lateral outer side of the workpiece;
wherein the upstream clamping assembly is decoupled from the rotatability of the band saw frame;
wherein the first upstream clamping element is movably arranged along a first horizontal clamping path extending with a clamping angle relative to the X-direction; and
wherein the first upstream clamping element is additionally moveably arranged upstream and downstream along a path parallel to the X-direction.

3. The machining system according to claim 1, wherein the downstream clamping assembly is an active clamping assembly when the first and the second lateral outer sides of the downstream workpiece section are long enough to firmly clamp the downstream workpiece section with the first and the second downstream clamping elements, wherein a position of the first downstream clamping element is within a distance of less than 20 mm or less than 10 mm of the sawing path when the predetermined sawing angle of the sawing path is within the negative sawing angle range, and wherein the first downstream clamping element is arranged perpendicularly opposite the second downstream clamping element when the predetermined sawing angle of the sawing path is zero or is within the positive sawing angle range.

4. The machining system according to claim 2, wherein the upstream clamping assembly is an active clamping assembly when at least one of the first and the second lateral outer sides of the downstream workpiece section is too short to firmly clamp the downstream workpiece section with the first and the second downstream clamping elements, wherein a position of both the first upstream clamping element and the second upstream clamping element are within a distance of less than 20 mm or less than 10 mm of the sawing path when the predetermined sawing angle of the sawing path is within the positive sawing angle range, and wherein the first upstream clamping element is arranged perpendicularly opposite the second upstream clamping element when the predetermined sawing angle of the sawing path is zero or is within the negative sawing angle range.

5. The machining system according to claim 2, wherein the clamping angle of the first horizontal clamping path along which the first upstream clamping element is moveable relative to the X-direction is in a range of 10° to 80°.

6. The machining system according to claim 2, wherein the second upstream clamping element is movably arranged along a second horizontal clamping path extending with a clamping angle relative to the X-direction, the clamping angle being in a range of 10° to 80°.

7. The machining system according to claim 1, wherein the conveying assembly comprises a passage at the sawing assembly and wherein the sawn-off workpiece section can fall through the passage for removal thereof when the sawn-off workpiece section is smaller than the passage.

8. The machining system according to claim 2, further comprising a gripper truck assembly for transporting the workpiece in the X-direction, wherein the gripper truck assembly comprises a gripper head comprising a gripper head main body having a first jaw and a second jaw for engaging two opposite lateral outer sides of the workpiece, the opposite lateral outer sides each extending in a respective vertical plane, the first jaw being configured to be translationally actuatable with respect to the second jaw along a jaw translation path extending parallel to the Y-direction for thereby engaging one of the opposite lateral outer sides.

9. The machining system according to claim 8, additionally comprising a support roller assembly positioned upstream of the second upstream clamping element and configured for supporting either the workpiece or the gripper head of the gripper truck assembly.

10. The machining system according to claim 9, wherein the support roller assembly comprises:
a static roller rotatable around a vertical axis, a circumferential roller surface of the static roller being positioned at a backside of the vertical datum line plane at a distance from the vertical datum line plane, wherein the static roller is configured to support the gripper head when the gripper head is moved downstream in the X-direction beyond the static roller; and
a pivoting roller rotatable around a second vertical axis, said second vertical axis being positionable at a first position and a second position, wherein a circumferential roller surface of the pivoting roller is tangentially aligned with the vertical datum line plane when being in the first position so as to engage and support the workpiece, wherein the circumferential roller surface of the pivoting roller is at a backside of the vertical datum line plane at a second distance from the vertical datum line plane so as to allow to pass the gripper head to pass when the gripper head is moved downstream in the X-direction beyond the pivoting roller.

11. The machining system according to claim 6, further comprising a gripper truck assembly for transporting the workpiece in the X-direction, wherein the gripper truck assembly comprises a gripper head comprising a gripper head main body having a first jaw and a second jaw for engaging two opposite lateral outer sides of the workpiece, the opposite lateral outer sides each extending in a respective vertical plane, the first jaw being configured to be translationally actuatable with respect to the second jaw along a jaw translation path extending parallel to the Y-direction for thereby engaging one of the opposite lateral outer sides, wherein the second upstream clamping element is movable away from the vertical datum line plane at a backside of the vertical datum line plane at a distance from the vertical datum line plane so as to provide space for the second jaw of the gripper head to move along the second upstream clamping element in the X-direction, wherein the second upstream clamping element in a clamping position is moved towards the second lateral outer side of the workpiece against the second jaw of the gripper head so that the second jaw is interposed between the workpiece and the second upstream clamping element and a clamping force of the first upstream clamping element is transferred via the first jaw of the gripper head, the workpiece, and the second jaw of the gripper head to the second upstream clamping element.

12. The machining system according to claim 1, wherein the negative sawing angle range extends from −70° to 0° or from −60° to 0° and wherein the positive sawing angle range extends from 0° to 60° or from 0° to 45°.

13. A method of sawing a metal workpiece to divide the workpiece into an upstream workpiece section and a downstream workpiece section, the workpiece having a workpiece main axis, a first lateral outer side and a second lateral outer side opposite the first lateral outer side, the method comprising:
providing a machining system according to claim 1;
conveying the workpiece on the conveying assembly along a transport path in the X-direction to the sawing assembly with the workpiece main axis parallel to the X-direction and the second lateral outer side extending in a vertical datum line plane and the workpiece being at a frontside of the vertical datum line plane;
using the downstream clamping assembly to clamp the downstream workpiece section with the first and the second downstream clamping elements, wherein the using of the downstream clamping assembly includes:
positioning at least the first downstream clamping element along the X-direction so as to be within a predetermined distance from a sawing path when a predetermined sawing angle of the sawing path is within the negative sawing angle range, wherein the predetermined distance is less than 20 mm or less than 10 mm, or alternatively
positioning at least the first downstream clamping element perpendicularly opposite a second downstream clamping element when the predetermined sawing angle of the sawing path is zero or is within the positive sawing angle range; and
moving the first downstream clamping element towards the second downstream clamping element to clamp the downstream workpiece section of the workpiece;
using the sawing assembly during the clamping of the downstream workpiece section to saw off the downstream workpiece section; and
transporting a sawn-off workpiece section away from the sawing assembly downstream along the X-direction by simultaneously moving the first and the second downstream clamping elements downstream along the X-direction.

14. The method according to claim 13, wherein the machining system comprises an upstream clamping assembly having a first upstream clamping element for laterally engaging the first lateral outer side of the workpiece and having a second upstream clamping element for laterally engaging the second lateral outer side of the workpiece, wherein the upstream clamping assembly is decoupled from the rotatability of the band saw frame, wherein the first upstream clamping element is movably arranged along a first horizontal clamping path extending with a clamping angle relative to the X-direction, wherein the first upstream clamping element is additionally moveably arranged upstream and downstream along a path parallel to the X-direction,
wherein the method further comprises:
using the upstream clamping assembly, wherein the using of the upstream clamping assembly includes:
positioning at least the first upstream clamping element along the path parallel to the X-direction so as to be within a second predetermined distance from the sawing path when the predetermined sawing angle of the sawing path is within the positive sawing angle range, wherein the predetermined distance is less than 20 mm or less than 10 mm, or alternatively
positioning the first upstream clamping element along the path parallel to the X-direction so as to be perpendicularly opposite the second upstream clamping element during the actual clamping when the predetermined sawing angle of the sawing path is zero or is within the negative sawing angle range, and
moving the first upstream clamping element along the first horizontal clamping path towards the second upstream clamping element to clamp the upstream workpiece section of the workpiece;
using the sawing assembly during the clamping of the upstream workpiece section to saw off the downstream workpiece section.

15. The method according to claim 14, wherein during clamping of the upstream workpiece section by the upstream clamping assembly, the downstream clamping assembly is not clamping the downstream workpiece section and vice versa.

16. The method according to claim 15, wherein after sawing off the downstream workpiece section, the downstream clamping assembly is activated to clamp the sawn-off downstream-workpiece section and is subsequently controlled to transport the sawn-off downstream workpiece section downstream along the X-direction.

17. The method according to claim 14, wherein the machining system further comprises a gripper truck assembly for transporting the workpiece in the X-direction, wherein the gripper truck assembly comprises a gripper head comprising a gripper head main body having a first jaw and a second jaw for engaging two opposite lateral outer sides of the workpiece, the opposite lateral outer sides each extending in a respective vertical plane, the first jaw being configured to be translationally actuatable with respect to the second jaw along a jaw translation path extending parallel to the Y-direction for thereby engaging one of the opposite lateral outer sides,
wherein the method comprises adjusting a position of the second upstream clamping element away from the vertical datum line plane at a backside of the vertical datum line plane at a distance from the vertical datum line plane so as to provide space for the second jaw of the gripper head to move along the second upstream clamping element in a direction of the transport path, and wherein the method further comprises subsequently moving the second upstream clamping element in a clamping position by moving towards the second lateral outer side of the workpiece against the second jaw of the gripper head so that the second jaw is interposed between the workpiece and the second upstream clamping element and a clamping force of the first upstream clamping element is transferred via the first jaw of the gripper head, the workpiece, and the second jaw of the gripper head to the second upstream clamping element.

18. The method according to claim 14, wherein the machining system further comprises a gripper truck assembly for transporting the workpiece in the X-direction, wherein the gripper truck assembly comprises a gripper head comprising a gripper head main body having a first jaw and a second jaw for engaging two opposite lateral outer sides of the workpiece, the opposite lateral outer sides each extending in a respective vertical plane, the first jaw being configured to be translationally actuatable with respect to the second jaw along a jaw translation path extending parallel to the Y-direction for thereby engaging one of the opposite lateral outer sides,
wherein the machining system additionally comprises a support roller assembly positioned upstream of the second upstream clamping element and configured for supporting either the workpiece or the gripper head of the gripper truck assembly,
wherein the support roller assembly comprises:
a static roller rotatable around a vertical axis, a circumferential roller surface of the static roller being positioned at a backside of the vertical datum line plane at a distance from the vertical datum line plane, wherein the static roller is configured to support the gripper head when the gripper head is moved downstream in the X-direction beyond the static roller; and
a pivoting roller rotatable around a second vertical axis, said second vertical axis being positionable at a first position and a second position, wherein a circumferential roller surface of the pivoting roller is tangentially aligned with the vertical datum line plane when being in the first position so as to engage and support the workpiece, wherein the circumferential roller surface of the pivoting roller is at the backside of the vertical datum line plane at a second distance from the vertical datum line plane so as to allow the gripper head to pass when the gripper head is moved downstream in the X-direction beyond the pivoting roller,
wherein the method comprises adjusting the pivoting roller from the first position to the second position so as to allow the gripper head to pass the pivoting roller when the gripper head is moved downstream in the X-direction beyond the pivoting roller.

19. The machining system according to claim 5, wherein the clamping angle of the first horizontal clamping path along which the first upstream clamping element is moveable relative to the X-direction is in a range of 25° to 50°.

20. The machining system according to claim 6, wherein the clamping angle is in a range of 25° to 50°.
